(19) United States
(12) Patent Application Publication
(10) Pub. No.: US 2022/0241939 A1
(43) Pub. Date: Aug. 4, 2022

(54) WRENCH WITH A ROTARY HEAD

(71) Applicant: Yi-Fu Chen, Taichung City (TW)

(72) Inventor: Yi-Fu Chen, Taichung City (TW)

(21) Appl. No.: 17/586,674

(22) Filed: Jan. 27, 2022

(30) Foreign Application Priority Data
Feb. 2, 2021 (JP) JP2021-015319

(51) Int. Cl. B25B 23/00

(52) U.S. Cl. CPC B25B 23/0028; B25B 23/0035

(57) ABSTRACT

A wrench includes a function end having an extension portion extending therefrom. Two arms extend from the function end and toward a direction opposite to the extension portion. A space is formed between the two arms and the extension portion. An engaging portion is formed to the distal end of the extension portion for receiving a hand tool. A rotary head is pivotably located in the space of the function end by two bolts respectively extending through the two arms and connected to the rotary head. The rotary head includes an outer part and a control unit which is located in a through hole defined through the outer ring. The control unit includes a control part and a driving part respectively located on two opposite end of the rotary head. The control part is rotated to control the direction that the driving part rotates.

### BACKGROUND OF THE INVENTION

### 1. Fields of the Invention

The present invention relates to a wrench, and more particularly, to a ratchet wrench with a rotary head, and the ratchet is able to be connected with other hand tool.

### 2. Descriptions of Related Art

Wrenches are widely used today when assembling or dis-assembling items. However, there are different sizes and shapes of bolts and screws to be tightened or loosened, so that the wrenches are developed to include different sizes and functions to match the different items. In other words, the users may have to carry multiple wrenches to deal with the different items. The users carry unnecessary weight, and may even affect the operation. Therefore, how to make it easier for users to do their jobs easily is the goal to be pursued

The present invention intends to provide a wrench including a rotary head so as to meet different requirements during assembling work to eliminate the shortcomings mentioned above.

### SUMMARY OF THE INVENTION

The present invention relates to a wrench and comprises a function end having an extension portion extending therefrom. The function end also includes two arms extending in a direction opposite to the extension portion. A space is formed between the two arms and the extension portion. An engaging portion is formed to the distal end of the extension portion for receiving a hand tool. A rotary head is pivotably located in the space of the function end. Two bolts respectively extend through the two arms and are connected to the rotary head so that the rotary head is pivotable in the space of the function end. The rotary head includes an outer part and a control unit. The outer part includes a through hole defined therethrough. The control unit is located in the through hole and includes a control part and a driving part respectively located on two opposite end of the rotary head. The control part is rotated to control the direction that the driving part rotates.

The primary object of the present invention is to provide a wrench that includes a function end with an extension portion and a rotary head. The extension portion is able to be connected with other hand tool such as an extension rod, a socket wrench, a T-wrench to perform in different work sites. The rotary head is pivotable in the space of the function end, and the control part of the rotary head is rotated to control the direction that the driving part rotates. The users can only carry the function end without carrying many wrenches of different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is another perspective view to show the wrench of the present invention;

FIG. 3 is a plan view to show the imaginary lines of the wrench of the present invention;

FIG. 4 is a cross sectional view, taken along line IV-IV in FIG. 1;

FIG. 5 shows that the driving part is pivoted about the fifth imaginary line;

FIG. 6 shows that the extension portion is a hexagonal portion;

FIG. 7 is a cross sectional view, taken along line VII-VII in FIG. 6;

FIG. 8 shows that the wrench of the present invention is connected with a T-wrench;

FIG. 9 shows that the wrench of the present invention is connected with a socket wrench, and

FIG. 10 shows the wrench of the present invention and the socket wrench in FIG. 9.

### DETAILED DESCRIPTION OF THE PREFERRED EMBODIMENT

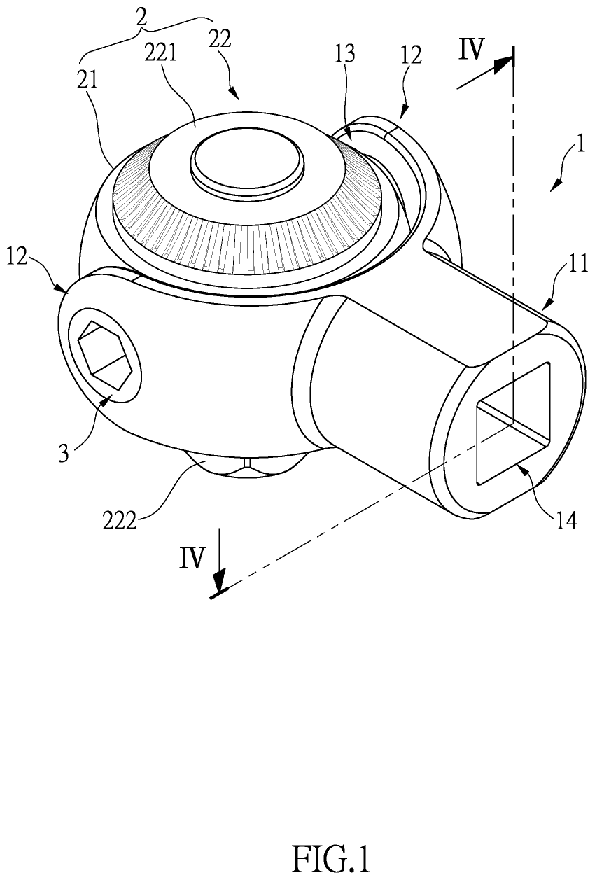

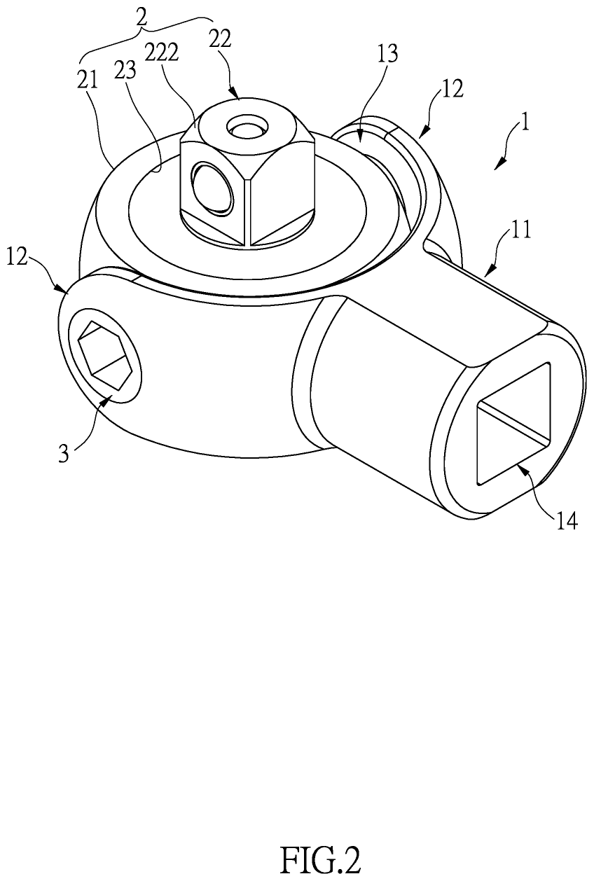

Referring to FIGS. 1 to 10, the wrench of the present invention comprises a function end 1 includes an extension portion 11 extending therefrom, and the function end 1 also includes two arms 12 extending in a direction opposite to the extension portion 11. Each arm 12 is a curve arm and a space 13 is formed between the two arms 12 and the extension portion 11. An engaging portion 14 is formed to the distal end of the extension portion 11 so as to receive a hand tool 10 therein. A rotary head 2 is pivotably located in the space 13 of the function end 1. Two bolts 3 respectively extend through the two arms 2 from outside of the two arms 2 and are connected to the rotary head 2 so that the rotary head 2 is pivotable in the space 13 of the function end 1. The rotary head 2 includes an outer part 21 and a control unit 22. The outer part 21 includes a through hole 23 defined centrally therethrough. The control unit 22 is located in the through hole 23. The control unit 22 includes a control part 221 and a driving part 222 respectively located on two opposite end of the rotary head 2 and protruding beyond the space 13. The control part 221 is rotated to control the direction that the driving part 222 rotates. The driving part 222 is to be connected with a hand tool 10 such as a socket. The rotary head 2 is pivotable in the space 13 to adjust the direction that the driving part 222 points.

The users can only carry the wrench of the represent invention and some hand tools 10 without carrying many different wrenches. The driving part 222 is to be connected with a hand tool 10 such as a socket, and the engaging portion 14 is to be connected to a hand tool 10 therein such as an extension rod. The rotary head 2 is pivotable in the space 13 to allow the driving part 222 to be pointed to a desired direction so as to output torque by using the control part 221 to control the direction that the driving part 222 rotates. By carrying the wrench of the present invention, the user can carry less weight of tools to finish his/her work.

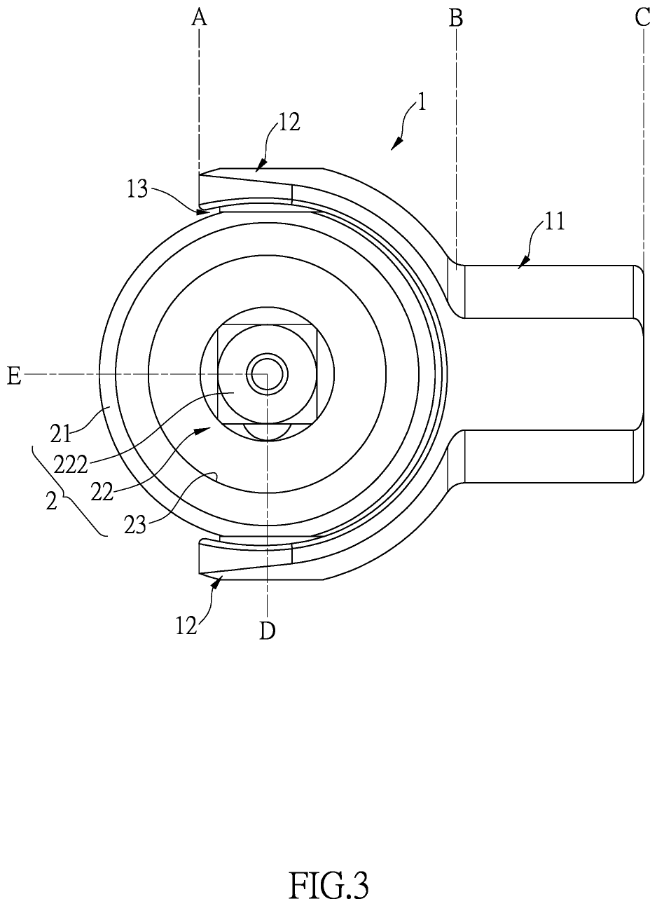

As shown in FIG. 3, the extension portion 11 is short so as to make the whole wrench small and light. A first imaginary line “A” is formed by passing the distal end of each of the arms 12. A second imaginary line “B” is formed by passing the middle point of a neck formed between the extension portion 11 and the two arms 12. The second imaginary line “B” is perpendicular to the axial axis of the extension portion 11. A third imaginary line “C” is formed by passing the distal end of the extension portion 11. The distance between the second and third imaginary lines “B”, “C” is shorter than the distance between the first and second imaginary lines “A”, “B”. The specific specification of the wrench of the present invention ensures that the output force from the wrench of the present invention is reliable. The two arms 12 are able to support the driving force when a hand tool 10 such as a socket is connected to the rotary head 2.

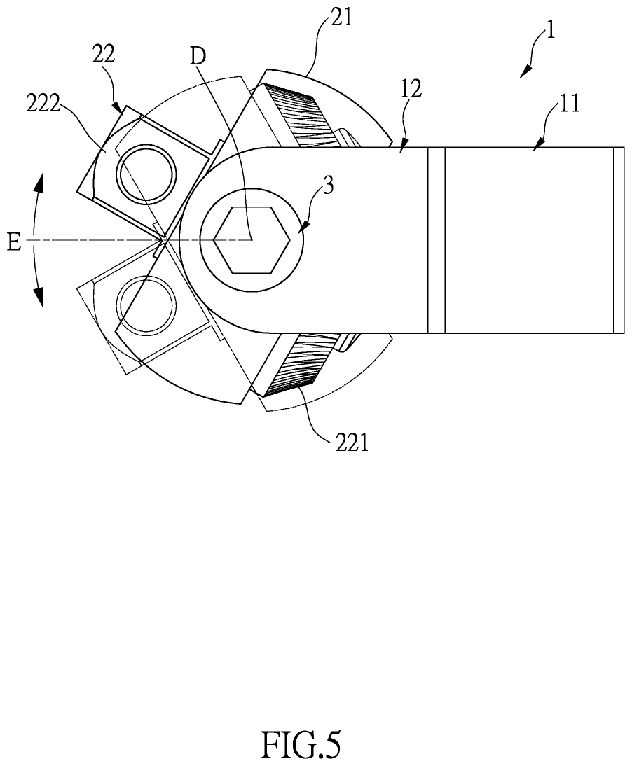

In addition, a fourth imaginary line “D” is formed by passing the central axis of each of the two bolts 3, and a fifth imaginary line “E” is formed by passing the axial axis of the extension portion 11. The fourth imaginary line “D” intersects the fifth imaginary line “E”. The rotary head 2 is pivoted about the fourth imaginary line “D”. The driving part 222 is pivotable about the fifth imaginary line “E” such that, as shown in FIG. 5, the driving part 222 swings from one of two sides of the fifth imaginary line “E” to another one of the two sides of the fifth imaginary line “E”. Therefore, the user can set the position of the rotary head 2 to proceed tightening or loosening work according practical needs.

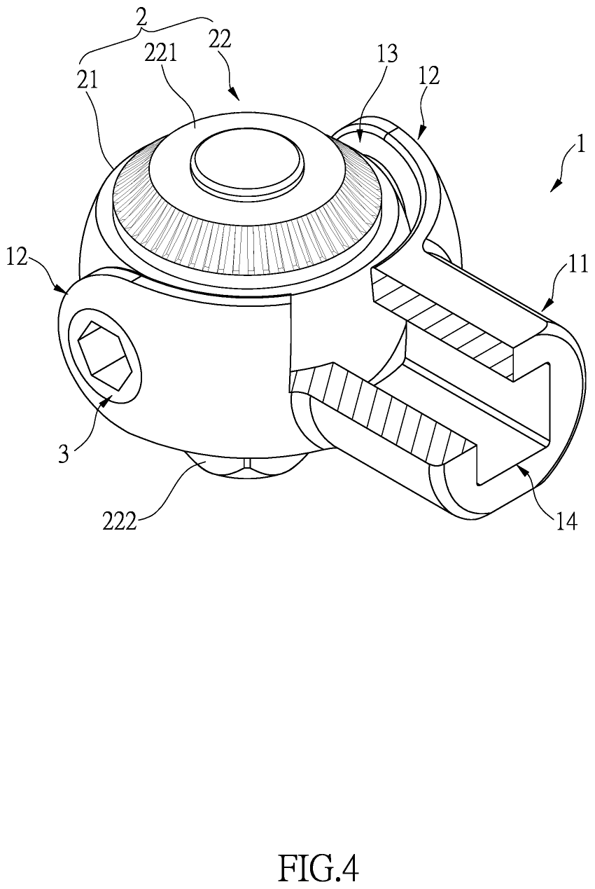

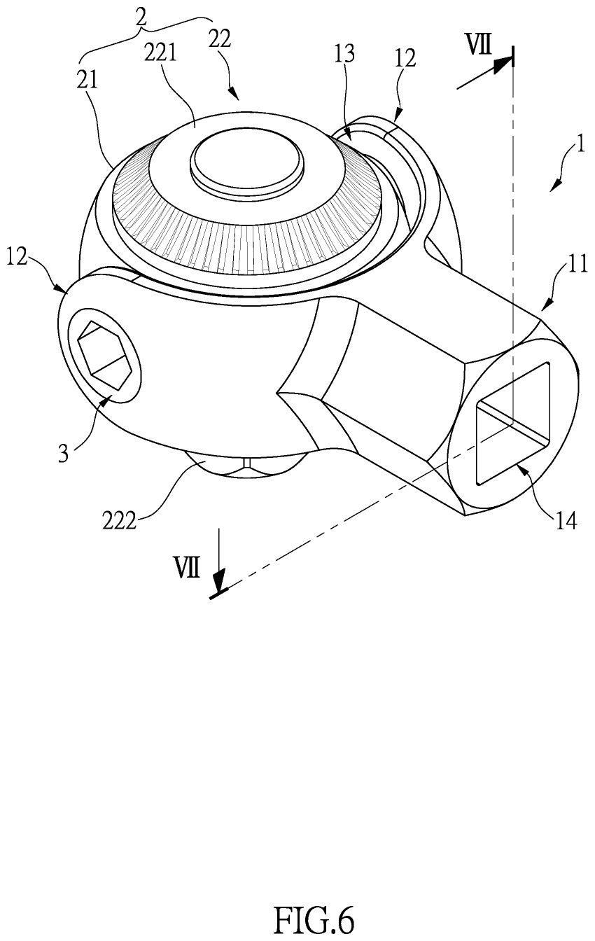

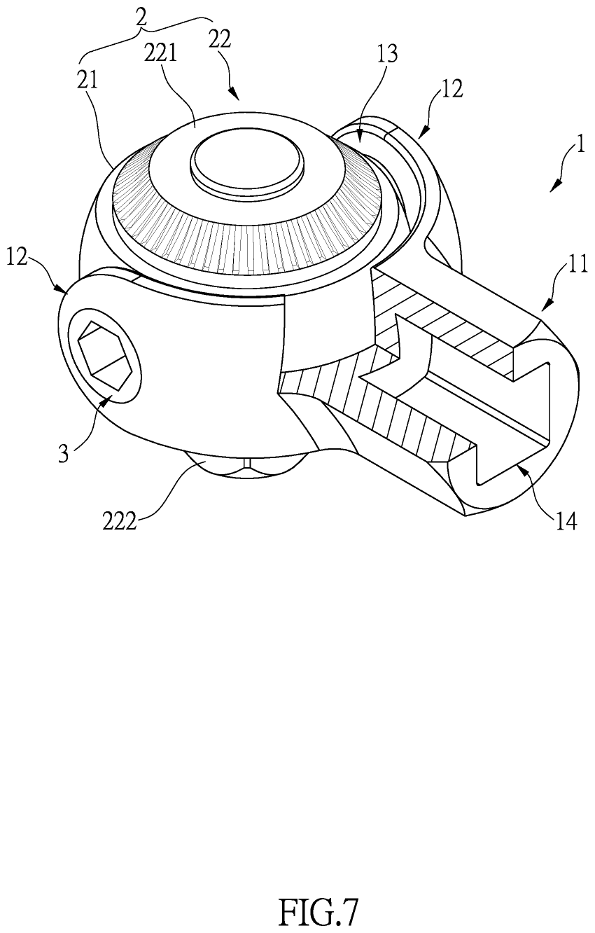

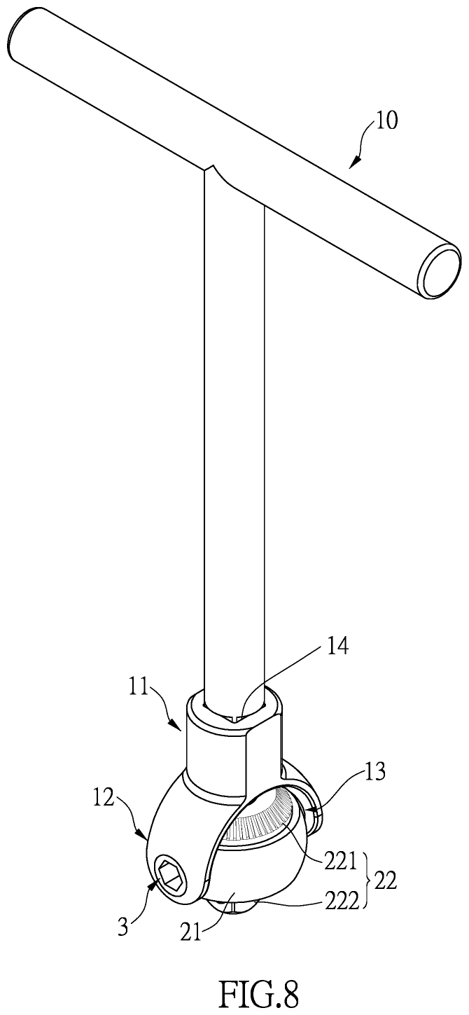

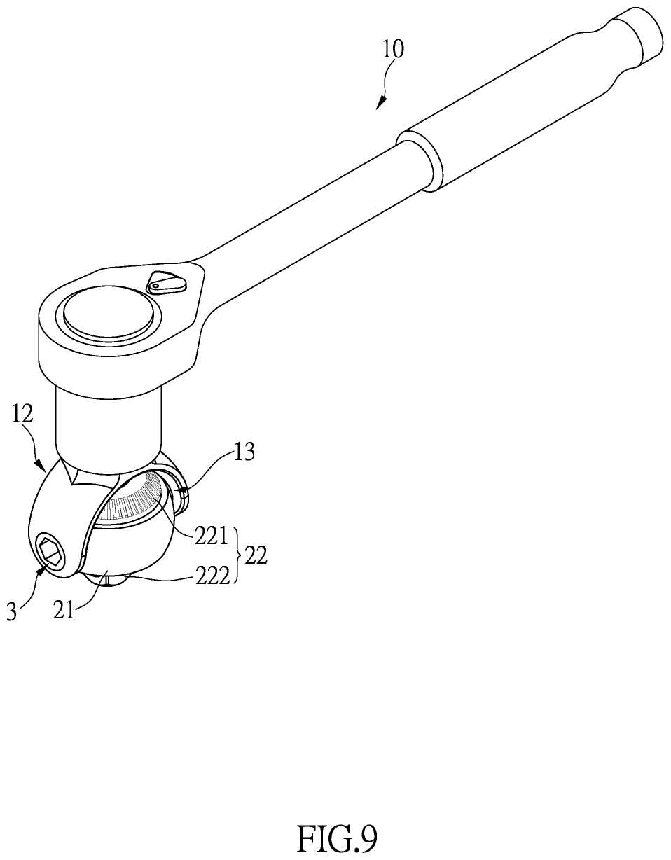

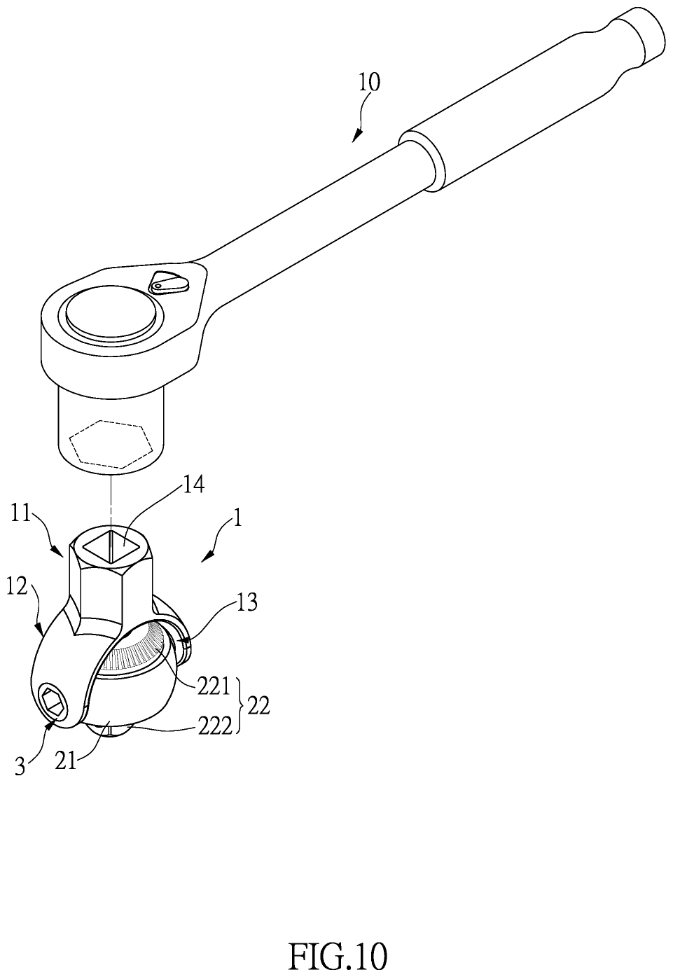

The extension portion 11 is a polygonal extension portion or a ball-shaped extension portion so as to be cooperated with other hand tools 10 such as a ratchet wrench or an open-box wrench. The ratchet wrench or the open-box wrench is inserted into the engaging portion 14 to operate the wrench of the present invention. FIGS. 9 and 10 show that a hand tool 10 such as a socket wrench is mounted to the extension portion 11 so as to drive the wrench of the present invention. The engaging portion 14 can be a through hole defined in the distal end of the extension portion 14. As shown in FIG. 4, the engaging portion 14 is a rectangular hole. Of course, the engaging portion 14 can be a polygonal hole, an octagon hole or a multiple-side hole. The engaging portion 14 can be a recess defined in the distal end of the extension portion 14. As shown in FIGS. 6 and 7, the engaging portion 14 can be a rectangular recess. Of course, the engaging portion 14 can be a polygonal recess, an octagon recess or a multiple-side recess. For example, a T-wrench is able to be connected to the engaging portion 14 as shown in FIG. 8. Therefore, different hand tools 10 can be connected to the engaging portion 14.

While we have shown and described the embodiment in accordance with the present invention, it should be clear to those skilled in the art that further embodiments may be made without departing from the scope of the present invention.

What is claimed is:

1. A wrench comprising:
a function end having an extension portion extending therefrom, the function end having two arms extending in a direction opposite to the extension portion, a space formed between the two arms and the extension portion, an engaging portion formed to a distal end of the extension portion and adapted to receive a hand tool, and
a rotary head pivotably located in the space of the function end, two bolts respectively extending through the two arms and connected to the rotary head so that the rotary head is pivotable in the space of the function end, the rotary head including an outer part and a control unit, the outer part including a through hole defined therethrough, the control unit located in the through hole, the control unit including a control part and a driving part respectively located on two opposite end of the rotary head and protruding beyond the space, the control part being rotated to control a direction that the driving part rotates.

2. The wrench as claimed in claim 1, wherein a first imaginary line is formed by passing a distal end of each of the arms, a second imaginary line is formed by passing a middle point of a neck formed between the extension portion and the two arms, the second imaginary line is perpendicular to an axial axis of the extension portion, a third imaginary line is formed by passing a distal end of the extension portion, a distance between the second and third imaginary lines is shorter than a distance between the first and second imaginary lines.

3. The wrench as claimed in claim 1, wherein a fourth imaginary lines is formed by passing a central axis of each of the two bolts, a fifth imaginary line is formed by passing an axial axis of the extension portion, the fourth imaginary line intersects the fifth imaginary line, the rotary head is pivoted about the fourth imaginary line, the driving part swings from one of two sides of the fifth imaginary line to another one of the two sides of the fifth imaginary line.

4. The wrench as claimed in claim 1, wherein the extension portion is a polygonal extension portion or a ball-shaped extension portion, the engaging portion is a through hole defined in a distal end of the extension portion, the engaging portion is a rectangular hole, a polygonal hole, an octagon hole or a multiple-side hole, or the engaging portion is a recess defined in a distal end of the extension portion, the engaging portion is a rectangular recess, a polygonal recess, an octagon recess or a multiple-side recess.
